(19) United States
(12) Patent Application Publication
(10) Pub. No.: US 2026/0099842 A1
(43) Pub. Date: Apr. 9, 2026

(54) SYSTEMS AND METHODS FOR USE IN IMPOSING RULES EXCEPTIONS

(71) Applicant: MASTERCARD INTERNATIONAL INCORPORATED, PURCHASE, NY (US)

(72) Inventors: Jacob Conoyer, Wildwood, MO (US); Brett J. Thomson, St. Peters, MO (US); David Vorhies, St. Charles, MO (US); Uttra Tetali, Dardenne Prairie, MO (US)

(21) Appl. No.: 18/906,047

(22) Filed: Oct. 3, 2024

(51) Int. Cl. G06Q 20/40

(52) U.S. Cl. CPC G06Q 20/4016

(57) ABSTRACT

Systems and methods are provided for imposing rules exceptions, based on extraneous data. One example computer-implemented method includes soliciting, from a first party, identification of a surge event for a product to be offered at the first party and then receiving from the first party, in response, the identification of the surge event. The identification of the surge event includes a duration of the surge event, a time/date of the surge event, and an expected volume of sales of the product during the surge event. The computer-implemented method then includes transmitting, to an issuer of accounts, a notification of the surge event. The notification includes the duration of the surge event, the time/date of the surge event, and the expected volume of sales during the surge event, whereby the issuer is permitted to impose an exception to one or more rules associated with the surge event.

### FIELD

The present disclosure generally relates to systems and methods for use in imposing rules exceptions in connection with surge events, and in particular, to imposing rules exceptions in connection with surge events, based on extraneous data notifications.

### BACKGROUND

This section provides background information related to the present disclosure which is not necessarily prior art.

Users are known to initiate interactions with parties in various manners. For example, a user (e.g., a consumer, etc.) may present a physical card, or other device, to a first party, to initiate payment from an account associated with the user to purchase a product (e.g., a good, a service, etc.) from the first party. The patterns of purchases from users and first parties may be used to flag interactions as being fraudulent, whereby notifications, or further authentication, may be used to protect the users and the first parties against the fraudulent interactions, etc.

### BRIEF DESCRIPTION OF DRAWINGS

The drawings described herein are for illustrative purposes only of selected embodiments and not all possible implementations, and are not intended to limit the scope of the present disclosure.

FIG. 1 illustrates an example system of the present disclosure suitable for use in imposing rules exceptions;

FIG. 2 is a block diagram of an example computing device that may be used in the system of FIG. 1; and

FIG. 3 is a flow diagram of an example method, which may be implemented in connection with the system of FIG. 1, for imposing rules exceptions, based on extraneous data.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

When users interact with first parties to purchase products (e.g., goods, services, etc.), the users may purchase the products through interactions directed to one or more accounts (e.g., credit accounts, prepaid accounts, etc.). From time to time, fraud models (broadly, rules) may be generated through one or more techniques to differentiate between “normal” interactions and “abnormal” interactions whereby the abnormal interactions may be flagged as nefarious activity. That is, the one or more rules define the interactions as normal, or not, based on the timing, amount, first party, currency, location, etc., of the interactions. Occasionally, the first parties offer specific products for sale (e.g., concert tickets, new shows, etc.), which, in turn, induce a surge in interactions with the first parties (i.e., surge events), which may inadvertently trigger the one or more rules aiming to curb nefarious activity, whereby the interactions are potentially flagged or declined (as abnormal interactions relative to the one or more rules) despite the interactions actually being legitimate interactions. This may lead to poor performance of the one or more rules and/or inability to adapt to surge events from a technical perspective, which may cause user frustration, friction and brand changes from users (e.g., issuer A to issuer B, etc.), and lost sales by the first parties, etc.

Uniquely, the systems and methods herein leverage extraneous data to instruct the imposition of exceptions to rules (e.g., fraud models, etc.), based on extraneous data, to accommodate surge events, etc.

In particular, for example, in connection with surge events, a processing network leverages authentication messaging to interrogate first parties to report, or the first parties report of, upcoming surge events. Upon being notified of an upcoming surge event, the processing network notifies issuers (or other service providers) of the surge events as extraneous data (relative to requests for specific interactions), indicating the potential to receive substantial volumes of interaction requests during the surge events. Based on the notification(s), the issuers are then enabled to impose exceptions to one or more rules aimed at nefarious activity, to permit specific requests for interactions that are part of or specific to the surge events to be handled and/or approved in a manner consistent with the additional extraneous data (rather than flagged or declined as nefarious activity outright based on the one or more rules).

In this manner, the processing network modifies existing authentication messaging to specifically query parties about surge events, which defines a new channel for communication of extraneous data related to surge events, and then connects the extraneous data about surge events to relevant issuers and service providers. As such, the functionality of the authentication messaging is extended, whereby the computing scheme technology underlying the messaging is improved through newly added functionality. Consequently, issuers or other service providers are informed with the extraneous data to better identify legitimate network traffic inconsistent with one or more rules, while continuing to identify actual nefarious network traffic.

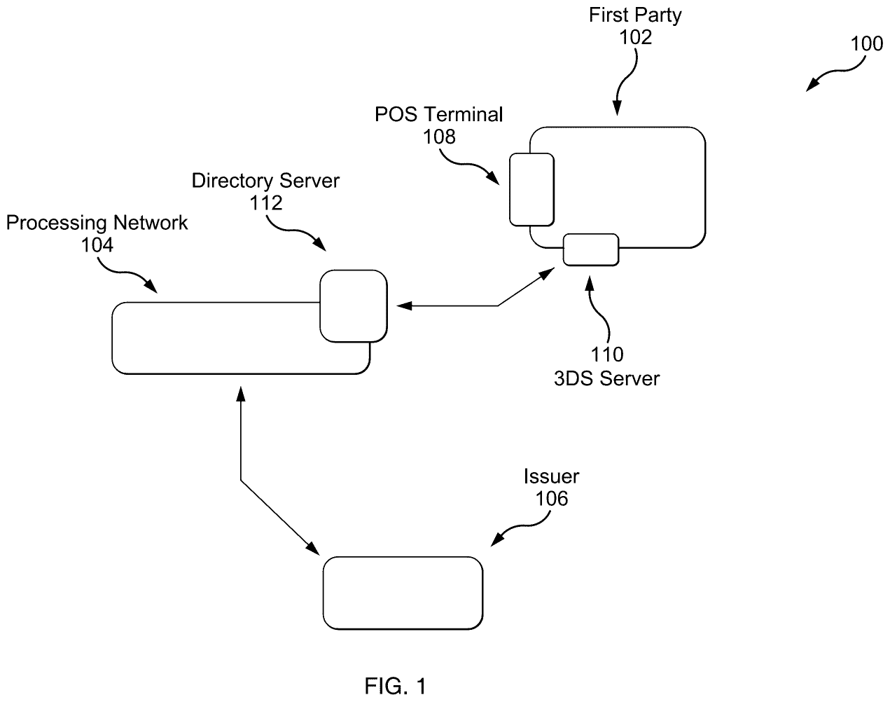

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, relationships between first parties, issuers, and/or processing network(s) in the system 100, privacy rules and regulations, etc.

As shown in FIG. 1, the illustrated system 100 generally includes a first party 102, a processing network 104, and an issuer 106, each of which is coupled to (and is in communication with) one or more network(s) (as indicated by the arrowed lines in FIG. 1). The one or more network(s) may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, one network may include a private payment network made accessible by the processing network 104 to the issuer 106 and, separately, the public Internet, which may provide interconnection between the first party 102 and the processing network 104, etc.

The first party 102 of the illustrated system 100, in general, offers products (e.g., goods, services, etc.) for sale and/or sells products to users. In this example embodiment, the first party 102 includes either a brick-and-mortar store (e.g., a physical store location, etc.) or a virtual merchant location, such as, for example, a website, network-enabled application, or a combination of such locations, etc. In one example, the first party 102 may offer tickets for sale (e.g., for concerts, sporting events, performances, or other events, etc.), which are made available for sale on a particular date through the first party 102. In another example, the first party 102 may offer clothing products (e.g., celebrity sponsored apparel, etc.), or technology products for sale (e.g., a latest smartphone, etc.), which are appealing, for example, to early adopters. In general, the first party 102 is configured to offer products for sale, for which the type of product is often associated with high demand upon the availability of the products.

The processing network 104 is configured to coordinate messaging associated with authorization of transactions between the first party 102 and other first parties and consumers (broadly, users) thereof, when a payment account is employed to funds the transactions.

Relatedly, the issuer 106 is configured to issue accounts, including, for example, payment accounts to users to be used to fund transactions at first parties, including the first party 102. As such, the issuer 106 is generally a financial institution, such as, for example, a bank, credit union, etc. In addition, the issuer 106 is configured to participate in the authorization of transactions to the accounts, through one or more approval processes, etc.

As shown in FIG. 1, the first party 102 includes a point-of-sale (POS) terminal 108. While FIG. 1 includes the POS terminal 108 generally at the first party 102, the POS terminal 108 may be embodied in a website or other network-enabled application to interact with users in connection with transactions to purchase products from the first party 102 (e.g., remotely, etc.). In connection with a transaction to the first party 102, a user presents a payment account issued by the issuer 106, in this example, to the POS terminal 108. In turn, the POS terminal 108 is configured to compile an authorization requests for the transaction to fund purchase of a product(s) at the first party 102. The authorization request includes, without limitation, an amount of the transaction, a time/date, a currency code, an account credential(s) (e.g., an account number, an expiration date, a CVC, a token, etc.), a transaction ID, a terminal ID, a merchant ID (MID), an acquirer bank identification number (BIN), a merchant category code (MCC), an address (for the first party 102, etc.), etc.

The POS terminal 108 is configured to transmit the authorization request to the issuer 106, via the processing network 104 and an acquirer (or payment service provider (PSP)) (not shown).

The issuer 106 is configured to receive the authorization request for the transaction via the processing network 104 and to then either approve the transaction or decline the transaction. Among other assessments of the transaction in connection with the above, the issuer 106 is configured to impose one or more rules associated with nefarious activities, such as, for example, fraud, etc. The one or more rules may be embodied in a machine learning model, which is trained based on, in part, the authorization request data associated with transactions determined to be based on nefarious activities and potentially, transactions determined not to be based on nefarious activities. The machine learning model, then, is configured to identify nefarious activities from the authorization request data, such as, for example, without limitation, timing, transaction amount, merchant category code (MCC), currency, location, first party, etc. In this way, the issuer 106 is configured to impose the one or more rules to incoming authorization requests for individual transactions, based on the authorization request data therein, and to designate ones of the transactions as nefarious activity, where the transactions exhibit patterns in the authorization request data that are associated with fraudulent transactions (or violate the rules). The one or more rules may be applied individually to each of the transactions, whereby the specific authorization request data is leveraged, or across many transactions. As such, the patterns then may further include, without limitation, transaction velocity, frequency, time of day, amount, etc., or other features of the data included in the authorization requests, etc.

In connection with the above, from time to time, the first party 102 is configured to offer products for sale which cause a surge in transactions, whereby users initiate unusually large volumes of transactions to purchase the products from the first party 102. This surge in transactions is referred to herein as a surge event. One example surge event includes concert tickets for an artist's tour, where the tickets go on sale on a particular time/date and sell out within a brief interval (e.g., one hour, hours, days, etc.). Another example surge event includes a unique shoe, where the shoe goes on sale on a particular time/date and sells out within a brief interval (e.g., hours, days, etc.). A further example surge event may include a launch of a gaming system, smartphone, or an application, etc., where each goes on sale on a particular time/date and sells out within a brief interval (e.g., hours, days, etc.). The surge event may be associated with the demand from persons based on limited supply of the products, status signals associated with the products, early adopter behaviors, etc.

In general, however, the surge events include the offer for sale of any product(s), which drive a threshold volume of transactions (in count or dollars) with the first party 102 (or multiple parties) in a limited interval (e.g. an hour, multiple hours, up to a day, etc.) (e.g., an accumulation (or amount) of spend in dollars (or other currency), an accumulation in count (or number) of transactions, etc. per interval). In various embodiments, accumulation of the amount of spend or number of transactions may be performed by the processing network 104 (e.g., the processing network may track the accumulation(s) for a given time period, etc.), or it may be performed by the issuer 106 (with regard to accounts associated with the issuer and involved in the transactions).

As recognized herein, the surge event (e.g., the determined accumulation(s) associated therewith, etc.) may be incompatible with the one or more rules applied by the issuer 106 to avoid nefarious activities (e.g., in relation to the threshold volume of transactions that may be associated with the surge events, etc.). As such, in this example embodiment, the processing network 104 is configured to coordinate messaging associated with one or more surge events.

In particular, in this embodiment, the processing network 104 is configured consistent with one or more enhanced authentication schemes, such as, for example, the EMV 3D Secure (3DS) protocol (e.g., 3DS 2.3.1 protocol, etc.) (see, e.g., www.emvco.com/emv-technologies/3d-secure/, which is incorporated herein by reference), etc.). As such, the system 100 further includes a 3DS server 110 and a directory server 112 as parts of the authentication scheme/architecture. The 3DS server 110 is incorporated in and/or associated with the first party 102, whereby reference herein to the first party 102 and the 3DS server 110 may be interchangeable. In addition, while the 3DS server 110 is illustrated as part of the first party 102, the 3DS server 110 may reside, in full or in part, at/in the processing network 104. The directory server 112 is associated, in this example, with the processing network 104 (e.g., MASTERCARD, VISA, etc. associated networks), and is configured as described below. It should be appreciated that an access control server (ACS) (not shown) may further be incorporated in and/or is part of the issuer 106 to help facilitate (or implement) the 3DS protocol. In connection with the above, the directory server 112 is configured to cooperate with the 3DS server 110 to enable operation messages, for example, between the processing network 104 and the first party 102. Operation messages can be independent of, or related to, a payment/non-payment authentication transaction.

In connection therewith, the directory server 112 is configured to transmit an operation request message (OReq) (e.g., consistent with the 3DS 2.3.1 protocol, etc.) to the 3DS server 110, at the first party 102, to interrogate the first party 102 about upcoming surge events. The OReq includes a request for identification of any surge events for the first party 102 in the next defined interval (e.g., day, week, month, etc.).

The 3DS server 110 is configured to solicit a response from the first party 102, whereby the first party 102 is configured to identify upcoming surge events in the interval, and transmit an operation response message (ORes) back to the directory server 112. The solicitation may include qualifications for a surge event (e.g., product types, sales channels (e.g., online, in person, etc.), locations, expected volume thresholds, etc.), so that the first party 102 is educated about what does and what does not qualify for a surge event. The ORes includes the merchant ID (or identifier of the 3DS Server 110), the message status, and a message extension including, without limitation, details of the surge event such as dates, countries, expected volumes (in counts or dollars (or other currencies)), merchant ID, acquirer BIN, MCC, currency, or other data that may be indicative of the expected transactions of the surge event, etc. It should be appreciated that if the surge event notification service is not supported by the first party 102, the 3DS server 110 is configured to respond with the ORes indicating the service is not supported.

The directory server 112 is configured to store the surge event data in a data structure (not shown) specific to surge events and to transmit the surge event details to the issuer 106 and one or more other issuers through separate OReqs (e.g., consistent with the 3DS 2.3.1 protocol, etc.) thereto. Each OReq includes a notification of the surge event, which includes all relevant details of the surge event, including, specifically, the expected timing of the surge event (i.e., date, time, etc.) and the expected volume, etc. Upon receipt, the issuer 106, for example, is configured to transmit a ORes indicating the receipt of the surge event data.

It should be appreciated that the operational messages (e.g., OReq, ORes, etc.) are provided for purposes of illustration and should not be considering limiting of the present disclosure, as other 3DS messages (in connection with payment/non-payment transactions) may be employed (e.g., message categories NPA, PA, IDCI, 3RI, etc. as explained in one or more versions of the EMV 3DS protocol) in other embodiments. In still other embodiments, the processing network 104 may be configured to expose an application programming interface (API) to the first party 102 for reporting the surge event(s) and associated details. Additionally, the processing network 104 may be configured to broadcast messages to first parties to solicit surge event identification. The request for surge events may even be delivered to the first parties, as part of an application, a service, etc., or via electronic mail (email), or other suitable messaging schemes, etc.

What's more, the example embodiment above includes the processing network 104 being configured to initiate reporting of the surge event(s), but in other example embodiments, the first party 102 may be configured to initiate reporting of the surge event(s), through one or more of the messaging schemes above. In still other embodiments, the issuer 106, or potentially, an acquirer associated with the first party 102, may be configured to initiate reporting of surge events.

Regardless, the issuer 106, in response to notification of the surge event(s) (i.e., extraneous data), is configured to then impose one or more exceptions to one or more rules associated with authorization of transactions related to the surge event(s). For instance, a rule may limit the velocity or volume of interactions at the first party 102, and the issuer 106 may be configured to impose one or more exceptions by raising the threshold for a period of time consistent with the surge event(s), or a part thereof (e.g., each of the first N hours, where N is an integer (e.g., 1, 2, 5, 10, etc.), etc.), or to suspend the threshold, for the same or a different period specific to the surge event(s). As an example, in response to the notification of the surge event(s), the issuer 106 may be configured to raise an amount threshold related to an authorization rule which is specific to the first party 102 from one million US dollars per thirty minutes to four million US dollars per thirty minutes for a period of six hours specific to the surge event(s). The exception(s) may be imposed on the one or more rules for an interval, which is the same as or potentially different than the indicated duration of the surge event(s).

It should be appreciated that the issuer 106 may be configured to impose any different type of exceptions to the one or more rules, from modification of the one or more rules, to suspending the one or more rules (and reinstating the one or more rules after the surge event(s)), etc.

It should be appreciated that in one or more embodiments, the processing network 104 may be configured to impose one or more rules exceptions, based on the surge event(s), for on-behalf of services for the issuer 106. That is, where the processing network 104 is configured to respond to authorization requests on behalf of the issuer 106, the processing network 104 may, consistent with the description above, be configured to impose similar rules exceptions to the above.

In addition to the above, the surge event notifications should not be understood to be limited to the issuer 106, or multiple issuers, as the surge event notifications consistent with the above may be provided to any service providers involved in the transactions.

As explained above, the processing network 104 is configured to coordinate messaging between the first party 102 and the issuer 106 to provide authorization of transactions, whereby an example user funds the purchase of one or more products, by and between the account of the user issued by the issuer 106 and an account of the first party 102 (e.g., issued by an acquirer (not shown), etc.). In this manner, the processing network 104 is configured to communicate, via the ISO 8583 standard, or ISO 20022 standard, with the issuer 106 and the first party 102 (or acquirer thereof), etc.

That is, when a user selects to purchase a product during a surge event, the user presents a payment credential for the payment account transaction to the first party 102, at the POS terminal 108.

As part of initiating the transaction, the first party 102 is configured to compile and transmit an authorization request for the transaction to the processing network 104, via an acquirer (not shown), which may include an 0100 message consistent with the ISO 8583 standard. The authorization request includes, without limitation, a time/date, currency code, account credential, merchant ID (MID), acquirer BIN, merchant category code (MCC), etc. Upon receipt of the authorization request, the processing network 104 is configured to transmit the authorization request to the issuer 106 (as associated with the user's account to which the transaction is directed).

The issuer 106 is configured to approve or decline the transaction based on the one or more rules associated with nefarious activity, while further considering also the one or more exceptions to the one or more rules imposed above. In this way, a transaction during the surge event that has exceeded a transaction velocity threshold, for example, may now be approved (rather than declined) based on that the exception(s). In various instances, the issuer 106 is configured, based on the imposed exception(s), to approve a transaction, which would have otherwise been declined based on a transaction velocity, or transaction amount, indicated in the one or more rules to which the exception is imposed. This is contrary to conventional techniques to apply the one or more rules directed to nefarious activities.

Once the transaction is authorized, the issuer 106 is configured to compile and transmit an authorization response for the transaction back to the first party 102 through the processing network 104.

While only one first party 102 and one issuer 106 are illustrated in FIG. 1, it should be appreciated that any number of these parts and/or entities (and their associated components) may be included in the system 100, or may be included as a part of systems in other embodiments, consistent with the present disclosure. Likewise, it should be appreciated that the system 100 and/or other system embodiments will generally include multiple users, each associated with an account for use in payments interactions with the first parties, etc.

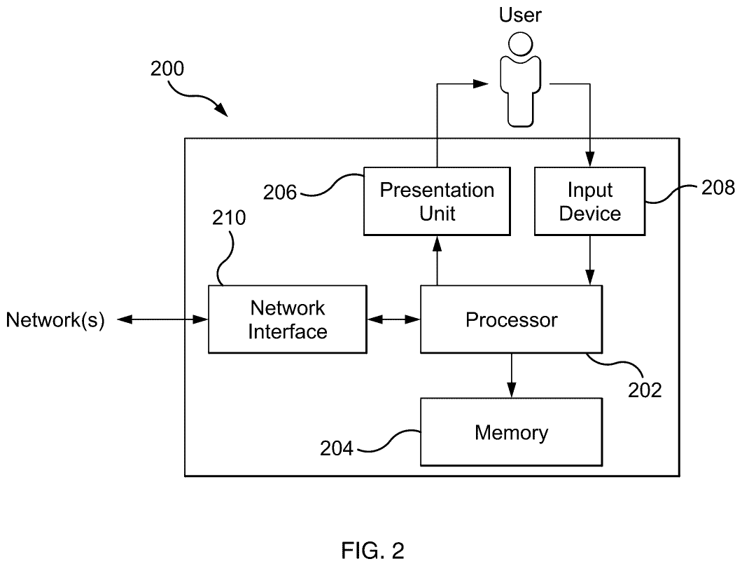

FIG. 2 illustrates an example computing device 200 that may be used in the system 100. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to operate as described herein. In the example embodiment of FIG. 1, each of the first party 102, the processing network 104, the issuer 106, the POS terminal 108, the 3DS server 110, and directory server 112 are understood to be included in, or as being generally implemented in, at least one computing device generally consistent with computing device 200, coupled to (and in communication with) the one or more networks. What's more, it should further be appreciated that the computing device 200 may be configured consistent with one or more cloud, fog, and/or mist computing architectures.

However, with that said, the system 100 should not be considered to be limited to the computing device 200, as described below, as different computing devices and/or arrangements of computing devices may be used.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices (e.g., EMV chips, etc.), flash drives, CD-ROMs, thumb drives, floppy disks, tapes, hard disks, and/or any other type of volatile or nonvolatile physical or tangible computer-readable media. The memory 204 may be configured to store, without limitation, details of surge events, rules and exceptions, and/or other types of data (and/or data structures) suitable for use as described herein. Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 and/or other computer system components configured to perform one or more of the various operations herein, whereby such performance improves operation of the computing device (as described herein) and transforms the computing device 200 into a special-purpose computing device. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, such as instruction to identify a surge event, etc., audibly or visually, for example, to a user of the computing device 200, etc. The presentation unit 206 may include, without limitation a liquid crystal display (LCD), a light-emitting diode (LED) or LED display, an organic LED (OLED) display, an “electronic ink” display, speakers, etc. In some embodiments, presentation unit 206 may include multiple devices.

In addition, the computing device 200 includes an input device 208 that receives inputs from the user of the computing device 200 (i.e., user inputs) such as, for example, details of surge events (e.g., duration, start time/date, volume, etc.), etc., as further described herein. The input device 208 may include a single input device or multiple input devices. The input device 208 is coupled to (and is in communication with) the processor 202 and may include, for example, a keyboard, a pointing device, a mouse, position sensors, biometric capturing device (e.g., fingerprint sensors, camera, palm reader, etc.) or any other type of sensor, a touch sensitive panel (e.g., a touch pad or a touch screen, etc.), another computing device, and/or an audio input device, etc. Further, in various example embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., Wi-Fi adapter, a near field communication (NFC) adapter, a Bluetooth adapter, etc.), a mobile network adapter, or other device capable of communicating to one or more different networks, including the one or more networks described above. Further, in some example embodiments, the computing device 200 may include the processor 202 and one or more network interfaces incorporated into or with the processor 202.

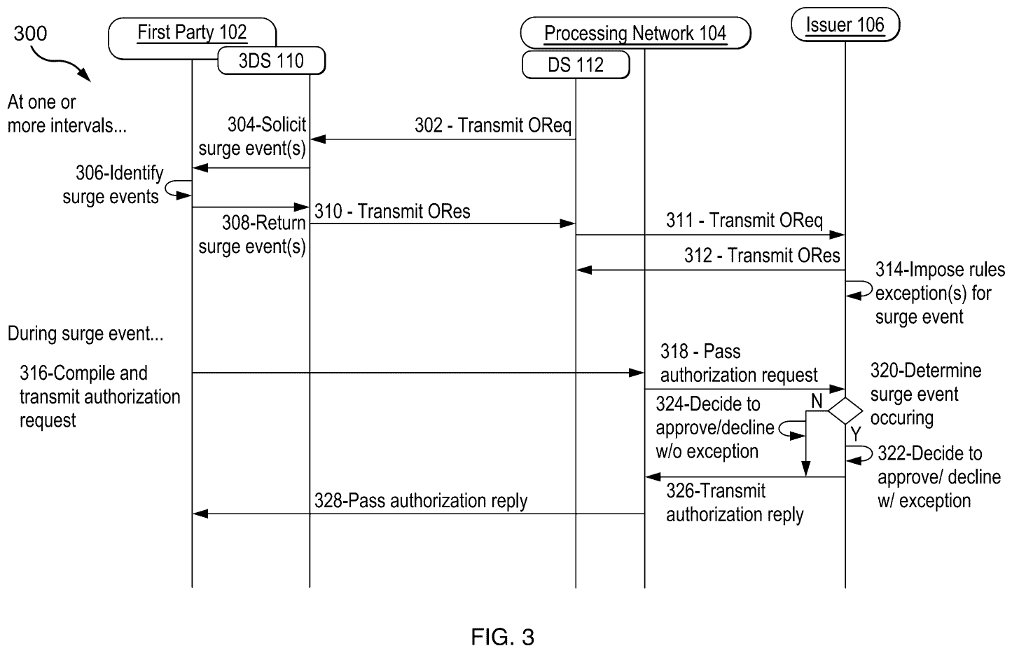

FIG. 3 illustrates an example method 300 for use in imposing rules exceptions, based on extraneous data. The example method 300 is generally described in connection with the system 100. Reference is also made to the computing device 200 of FIG. 2. However, the methods herein should not be understood to be limited to the system 100 or the computing device 200, as the methods may be implemented in other systems and/or computing devices. Likewise, the systems and the computing devices herein should not be understood to be limited to the example method 300.

At the outset, the first party 102 has been engaged to offer tickets to various concerts of a tour of a popular artist. The tickets are expected to sell out for the tour in less than three hours, and potentially, less than one hour. As such, there is an expectation to sell millions of tickets in that interval, which is set for March 1st at 1:00 pm. Thereafter, at one or more regular or irregular intervals (e.g., daily, weekly, monthly, etc.), the directory server 112 transmits, at 302, an operation request message (OReq) to the first party 102, and in particular, the 3DS server 110. The OReq is a request to identify any surge events that may be occurring at the first party 102 in the next week.

In turn, the 3DS server 110 solicits any surge event(s) from the first party 102, at 304. In doing so, the 3DS server 110 may solicit the surge event(s) from the first party 102 via the POS terminal 108 (e.g., via messaging, notifications, etc. presented at the POS terminal 108, etc.), or via another computing device of the first party 102 in communication with the 3DS server 110 (or with which the first party 102 communicates with the 3DS server 110) (e.g., via messaging, notifications, etc. presented at a display of the computing device, etc.). In doing so, the 3Ds server 110 may define a surge event by volume, frequency, etc., so that the first party 102 is permitted to identify any potential surge events.

The first party 102 identifies, at 306, in this example, that the tour tickets to be sold on March 1st at 1:00 pm is a surge event. It should be appreciated that other surge events may be identified in addition to the tour tickets in this example, and that other surge events of various types may be identified in other examples.

At 308, the first party 102 returns a description of the surge event(s) to the 3DS server 110, for example, via the POS terminal 108 or other computing device of the first party 102 in communication with the 3DS server 110. The description of the surge event include the dates, times, countries, merchant ID (and/or 3DS server ID), expected volume, duration, currency, etc., for the surge event(s). Here, then, the first party 102 returns the date of March 1, the time of 1:00 pm, the country as the U.S., the estimated sales volume of millions of tickets (and/or the equivalent dollar values), the duration of two hours or up to six hours, and the currency as USD, etc. It should be appreciated that any other details of the expected surge event may also be provided.

In turn, at 310, the 3DS server 110 compiles and transmits an operation response message (ORes) to the directory server 112. The ORes includes the merchant ID (and/or 3DS ID), a message status, and a message extension, which includes the details of the surge event returned from the first party 102.

The directory server 112 transmits, at 311, a second operation request message (OReq) to the issuer 106 (and specially, an access control server (ACS) thereof). The issuer 106 responds, at 312, with a second operation response message (ORes), which indicates an acknowledgement of receipt of the second OReq. In addition, in various examples, the directory server 112 may also transmit the second OReq to other issuers that may be affected by, impacted by, associated with, etc. the given surge event(s). In doing so, the directory server 112 may identify the other issuers based on a subscription (e.g., with the processing network, etc.) for such surge event notifications (in general, or with regard to specific products, specific surge events, specific merchants involved, specific merchant category codes (MCCs), specific card types, etc.). Additionally, or alternatively, the directory server 112 may identify the other issuers based on issuer cards (or card types) specific to (or related to) a particular category, and/or based on the issuers being high category issuers (e.g., issuers typically associated with high accumulated transaction counts, high accumulated transaction amounts, etc.).

As shown in FIG. 3, the issuer 106 imposes, at 314, one or more rules exceptions for the surge event, or more specifically, an interval based on the surge event. The interval may be the same as the stated duration of the surge event, or another period of time either longer or shorter than the surge event. In this example, an exception is imposed on a fifty thousand (50,000) transaction per hour threshold rule imposed by the issuer 106, where the rule had indicated transactions in excess of that threshold from the same first party 102 are automatically declined. Further, the exception is imposed for an interval specific to the surge event, which, in this example, includes March 1st from 1:00 pm to 7:00 pm.

It should be appreciated that various different types of exceptions may be imposed by the issuer 106, where the exceptions are tailored to the specific surge event, so as not to overly limit, undermine or eliminate rules unnecessarily.

Next, as shown in FIG. 3, a user, with a payment account issued by the issuer 106, initiates a transaction with the first party 102 to purchase concert ticket for the tour at 2:10 pm on March 1. In response, at 316, the first party 102 compiles an authorization request for the transaction (including all the relevant data) and transmits the authorization request to the processing network 104, via an acquirer (not shown).

At 318, the processing network 104 passes the authorization request to the issuer 106.

The issuer 106 determines, at 320, whether the surge event is occurring, or not. Because the transaction is initiated when the surge event is occurring, the issuer 106 approves or declined the transaction, at 322, with the exception. As such, regardless of the number of transactions in the last 70 minutes, since the surge event was started, there is an exception to the rule which limits the number of transaction to the fifty thousand (50,000) transaction per hour threshold. As such, the issuer 106 approves the transaction.

Conversely, had the surge event not been occurring, the issuer 106 determines, at 324, to approve or decline the transaction without the exception, whereby the fifty thousand (50,000) transaction per hour threshold would be applied in advance of approving the transaction. If that fifty thousand (50,000) transaction per hour threshold is violated, the issuer 106 automatically declines the transaction, or returns another indication of the suspected fraud. In at least one embodiment, the issuer 106 may require authentication of the user.

Thereafter, in either scenario, the issuer 106 compiles an authorization reply, which indicates the approval or decline of the transaction, and transmits, at 326, the authorization reply to the processing network 104. The processing network 104, in turn, passes, at 328, the authorization reply to the first party 102, via the acquirer.

In view of the above, the systems and method herein permit the imposition of exceptions to one or more rules based on the existence of surge events at specific first parties. That is, an enhanced functionality is layered into the authentication scheme implemented through the processing network (or other party involved in account transactions). In this way, the additional functionality permits the efficient flow of extraneous data from the first parties to the issuers (or payment networks), which monitor transactions for nefarious activities. The extraneous data then is leveraged to impose exceptions, where proper, to permit transactions (through the exception(s)), which permit issuers or other service providers to be informed with the extraneous data to better identify legitimate network traffic inconsistent with one or more rules, while continuing to identify actual nefarious network traffic.

As such, the authentication scheme/architecture herein is configured to perform operations not previously possible, and to provide efficient reduction of friction in transactions related to surge events.

Again, and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) soliciting, from a first party, identification of a surge event for a product to be offered at the first party; (b) receiving, from the first party, the identification of the surge event, the identification of the surge event including a duration of the surge event, a time/date of the surge event, and an expected volume of sales of the product during the surge event; (c) transmitting, by the computing device, to an issuer of accounts, a notification of the surge event, the notification including the duration of the surge event, the time/date of the surge event, and the expected volume of sales during the surge event, whereby the issuer is permitted to impose an exception to one or more rules associated with the surge event; (d) receiving, by the processing network, from an acquirer associated with the first party, an authorization request for a transaction during the duration of the surge event; (e) passing, by the processing network, the authorization request to the issuer; and/or (f) imposing the exception to the one or more rules for the duration of the surge event, whereby the one or more rules are inapplicable to transactions during the duration.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art, that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for imposing rules exceptions, based on extraneous data, the method comprising:
soliciting, from a first party, by a directory server (DS) computing device, consistent with an authentication scheme, via a server, identification of a surge event related to a product to be offered at the first party;
receiving, from the first party, by the DS computing device, the identification of the surge event, the identification of the surge event including a duration of the surge event, a time/date of the surge event, and an expected volume of the product during the surge event; and
transmitting, by the DS computing device, to an issuer of accounts, a notification of the surge event, the notification including the duration of the surge event, the time/date of the surge event, and the expected volume during the surge event, whereby the issuer is permitted to impose an exception to one or more rules associated with authorization of transactions for an interval related to the duration of the surge event.

2. The computer-implemented method of claim 1, wherein soliciting the identification of the surge event includes transmitting, by the computing device, an operation request (OReq) message consistent with an EMV 3D Secure (3DS) protocol indicative of the authentication scheme; and
wherein the directory server computing device is part of a processing network coupled in communication with the issuer.

3. The computer-implemented method of claim 2, wherein receiving the identification of the surge event includes receiving an operation response (ORes) message consistent with the EMV 3DS protocol, which includes an identifier of the first party and a message extension, which includes the duration of the surge event, the time/date of the surge event, and the expected volume during the surge event.

4. The computer-implemented method of claim 2, further comprising:
receiving, by the processing network, from an acquirer associated with the first party, an authorization request for a transaction during the duration of the surge event; and
passing, by the processing network, the authorization request to the issuer.

5. The computer-implemented method of claim 1, further comprising:
imposing, by a computing device of the issuer, the exception to the one or more rules for the interval based on the surge event, whereby the one or more rules are inapplicable to transactions during the interval, which is the same as the duration of the surge event.

6. The computer-implemented method of claim 1, wherein the first party is a merchant; and
wherein the product includes concert tickets.

7. The computer-implemented method of claim 1, wherein soliciting, by the computing device, the identification of the surge event includes soliciting, by the computing device, via an application programming interface (API), the identification of the surge event.

8. The computer-implemented method of claim 1, wherein the surge event for the product includes an amount of spend and/or a number of transactions for the product above a threshold value.

9. A system for imposing rules exceptions, based on extraneous data, the system comprising at least one computing device configured to:
solicit, from a first party, identification of a surge event for a product to be offered at the first party;
receive, from the first party, the identification of the surge event, the identification of the surge event including a duration of the surge event, a time/date of the surge event, and an expected volume during the surge event; and
transmit, to an issuer of accounts, a notification of the surge event, the notification including the duration of the surge event, the time/date of the surge event, and the expected volume during the surge event, whereby the issuer is permitted to impose an exception to one or more rules associated with authorization of transactions for the duration of the surge event.

10. The system of claim 9, wherein the at least one computing device includes a directory server (DS) computing device coupled in communication with a 3D Secure (3DS) server, which are part of a processing network coupled in communication with the issuer;
wherein the DS computing device is configured to transmit a first operation request (OReq) message consistent with an EMV 3DS protocol to the 3DS server; and
wherein the 3DS server is configured, in response to the first OReq message, to solicit the identification of the surge event from the first party.

11. The system of claim 10, wherein the 3DS server is configured to receive the identification of the surge event from the first party and to respond to the DS computing device with a first operation response (ORes) message consistent with the EMV 3DS protocol;
wherein the DS computing device is configured to receive the first ORes message from the 3DS server and to transmit the notification of the surge event as a second operation request (OReq) message consistent with the EMV 3DS protocol to the issuer; and
wherein the second OReq message includes an identifier of the first party and a message extension, which includes the duration of the surge event, the time/date of the surge event, and the expected volume during the surge event.

12. The system of claim 11, wherein the DS computing device is configured to receive a second operation response (ORes) message consistent with the EMV 3DS protocol, from the issuer, which indicates an acknowledgement of receipt of the second OReq message.

13. The system of claim 10, further comprising a processing network, which is configured to:
receive, from an acquirer associated with the first party, an authorization request for a transaction during an interval for the exception, the authorization request consistent with one of an ISO 20022 standard and an ISO 8583 standard; and
pass the authorization request to the issuer.

14. The system of claim 13, further comprising an issuer computing device configured to:
in response to the notification, impose the exception to the one or more rules associated with transactions during for the interval of the exception; and
in response to the authorization request:
determine that the authorization request is received within an interval for the exception; and
based on determining that the surge event is still occurring, approve the transaction based on the exception, despite the one or mor rules indicating decline of the transaction based on data included in the authorization request and/or other transactions.

15. The system of claim 9, wherein the at least one computing device is configured to solicit the identification of the surge event, form the first party, via an application programming interface (API).

16. The system of claim 9, wherein the one or more rules includes an amount of spend and/or a number of transactions above a threshold value.

17. A non-transitory computer-readable storage medium comprising executable instructions for use in imposing rules exceptions, based on extraneous data, which when executed by at least one processor, cause the at least one processor to:
solicit, from a first party, identification of a surge event for a product to be offered at the first party;
receive, from the first party, the identification of the surge event, the identification of the surge event including a duration of the surge event, a time/date of the surge event, and an expected volume of sales of the product during the surge event; and
transmit, to an issuer of accounts, a notification of the surge event, the notification including the duration of the surge event, the time/date of the surge event, and the expected volume of sales during the surge event, whereby the issuer is permitted to impose an exception to one or more rules associated with authorization of transactions during the surge event.

18. The non-transitory computer-readable storage medium of claim 17, wherein the executable instructions, when executed by the at least one processor, cause the at least one processor, in soliciting the identification of the surge event, to: transmit an operation request (OReq) message consistent with an EMV protocol or solicit identification of the surge event, via application programming interface (API).

19. The non-transitory computer-readable storage medium of claim 18, wherein the executable instructions, when executed by the at least one processor, cause the at least one processor, in receiving the identification of the surge event, to receive an operation response (ORes) message consistent with the EMV protocol, which includes an identifier of the first party and a message extension, which includes the duration of the surge event, the time/date of the surge event, and the expected volume of sales during the surge event.

20. The non-transitory computer-readable storage medium of claim 18, wherein the executable instructions, when executed by the at least one processor, further cause the at least one processor to impose the exception to the one or more rules for the duration of the surge event, whereby the one or more rules are inapplicable to transactions during the duration; and
wherein the surge event for the product includes an amount of spend and/or a number of transactions for the product above a threshold value.
